(19) United States
(12) Patent Application Publication
(10) Pub. No.: US 2011/0109582 A1
(43) Pub. Date: May 12, 2011

(54) DISPLAY DEVICE

(75) Inventor: Naoki Masazumi, Kobe-shi (JP)

(73) Assignee: Konica Minolta Holdings, Inc., Tokyo (JP)

(21) Appl. No.: 13/003,643

(22) PCT Filed: Jun. 26, 2009
(86) PCT No.: PCT/JP2009/061735

§ 371 Date: Jan. 11, 2011

(30) Foreign Application Priority Data
Jul. 17, 2008 (JP) 2008-185866

(51) Int. Cl. G06F 3/041; G06F 3/038

(52) U.S. Cl. 345/173; 345/211

(57) ABSTRACT

Provided is a reflective type display device which can display handwritten image at a practical speed regardless of the handwriting input timing, without degrading the display characteristic of electrochemical display elements. The reflective type display device comprises: a first memory for storing a value X of the next display density to be displayed; a second memory for storing a value Y of the display density being displayed; and a driver for applying a write current to the respective electrochemical display element in accordance with a comparison result of the value X and Y.

### TECHNICAL HELD OF THE INVENTION

The present invention relates to display devices.

### BACKGROUND

In recent years, along with the improvement in the speed of operation of personal computers, spreading of network infrastructure, data storage coming to have large capacities, and reduction in price, opportunities are increasing more and more for obtaining and viewing documents and images, etc., that were conventionally provided in the form of paper printed matter, as simple electronic information.

As a display device for viewing such electronic information, the conventional liquid crystal displays or CRTs, or in recent years, light emitting types such as organic EL displays, etc., are being used. In particular, when the electronic information is document information, while it is necessary to watch the display device intently for relatively long periods of time, as a drawback of the conventional display devices, it has been generally known that the eyes get strained due to flickering.

Reflection type displays using external light have been known as the display devices for correcting this drawback.

As a display method for realizing such a reflection type display, the electrodeposition method has been known that uses the precipitation from solutions of metals or salt of metal (this method is hereinafter abbreviated as the ED method). The ED method has various advantages such as, possible to be driven at a relatively low voltage, having a simple cell structure, excellent in the contrast between black and white and the black quality, etc. (see Patent Document 1 and Patent Document 2).

However, in a display device of the ED method, since a certain amount of time is required for the precipitation or dissolution of metal, when an attempt is made to display the handwritten information input from a touch panel simultaneously with the inputting of the information, there is the problem that the display speed cannot keep up with the handwriting speed. In a conventional liquid crystal panel, etc., the handwritten input information from the touch panel is stored in a memory, and the screen is scanned based on this information from the memory, and then the handwritten information is displayed. In a case like liquid crystal display panel, since the response speed is fast, there was no problem even in this method of display. However, in a case of display device of the ED method, if this display method is used as it is, the display cannot keep up with the writing speed, and the handwritten information is displayed after a delay, which leads to poor operational performance.

In order to solve such a problem, in Patent Document 3 a method of writing in a short time corresponding to the position of the pen by applying voltages to the X and Y electrode terminals of the display device directly from the location information (X, Y) at each instant of time that is generated by the pen for handwriting has been proposed.

In Patent Document 3, at the time of writing corresponding to the position of the pen, high speed display driving has been made possible by applying for a short time a voltage exceeding the threshold voltage at which crystals start precipitating and forming crystals that become the nuclei. Further, since the display density of the handwritten part is insufficient with only the formation of crystals that become the nuclei, the display density is supplemented by additional writing.

### PRIOR TECHNICAL DOCUMENTS

### Patent Documents

Patent Document 1: Japanese Patent Publication No. 3428603.
Patent Document 2: Unexamined Japanese Patent Application Publication No. 2003-241227.
Patent Document 3: Unexamined Japanese Patent Application Publication No. 2004-29399.

### SUMMARY OF THE INVENTION

### Problems to be Solved by the Invention

However, in the method disclosed in Patent Document 3, if a new handwriting input is made while the additional writing is being done to supplement the display density, there is a problem that until the additional writing is completed it is not possible to display the image of the new handwriting input that has been made. In addition, when an overlapping handwriting input is made in the same location, since a voltage exceeding the threshold voltage is applied to the electrochemical display element several times, the amount of precipitation of metal becomes excessive, and the problem occurs that the displayed image becomes difficult to be erased even if an erasing voltage is applied.

The present invention was developed considering the above problem, and the purpose is to provide a reflection type display device capable to display the information input by handwriting at a practical speed without losing the characteristics of the electrochemical display element.

### Means for Solving the Problems

The purpose of the present invention can be achieved by the following structures.

1. A display device having a display screen constituted by matrix-arranged electrochemical display elements and displaying an image by applying writing electric currents corresponding to the display densities to be displayed to said respective electrochemical display elements, wherein the display device comprises;

a first memory for storing display density values X to be displayed next respectively in each electrochemical display element;

a second memory for storing display density values Y being currently displayed respectively in each electrochemical display element;

an input section for inputting location information on the display screen;

a first updating section for updating the display density value X stored in said first memory corresponding to the location information which has been input from the input section based on the location information;

a comparison section which compares the display density value X stored in said first memory with the display density value Y stored in said second memory corresponding to the display density value X;

a driver for applying a writing current to each electrochemical display element based on the result of comparison by said comparison section; and,

a second updating section that updates the display density value Y which is being stored in said second memory along with the application of the writing current by said driver.

2. The display device described in Structure 1 above, wherein the driver applies a writing current to the electrochemical display element for which said comparison section has determined that X>Y.

3. The display device described in Structures 1 or 2 above, wherein said control section is further provided with a third storage section for storing the display density values X of a plurality of pages to be stored in said first memory.

4. The display device described in any one of Structures 1 to 3 above, wherein said first memory is a FIFO memory, and the updating of the display density value X being stored in said first memory by said first updating section and the comparison of the display density value X and the display density value Y by said comparison section are performed asynchronously.

5. The display device described in any one of Structures 1 to 4 above, wherein said input section is a touch panel provided in the top layer of said display screen.

### Effect of the Invention

According to the present invention, in a display device using electrochemical display elements, it is possible to display the information input by handwriting at a practicable speed.

### BRIEF DESCRIPTIONS OF THE DRAWINGS

FIG. 1 is an external view showing an example of a display device according to an embodiment of the present invention.

FIG. 2 is an outline cross-sectional view showing the basic construction of an electrochemical display element 1 of the ED method used in a display device according to the embodiment of the present invention.

FIG. 3 is a diagram showing the construction of a display device according to the first embodiment of the present invention.

FIG. 4 is a time chart showing the changes in the respective sections during one example of the writing operations of a display device according to the present embodiment.

FIG. 5 is a diagram explaining the display density D of a display element 1 in the present embodiment.

FIG. 6 is a flow chart explaining the interrupt processing by handwriting input in the present embodiment.

FIG. 7 is a flow chart explaining the interrupt processing by button operation in the present embodiment.

FIG. 8 is a flow chart explaining the interrupt processing by a display controller 11 in the present embodiment.

FIG. 9 is an explanatory diagram explaining an example of handwriting input operations of the display device 100.

FIG. 10 is a time chart schematically showing the display density values that are stored in the first frame memory 60 and the second frame memory 61 in time series.

FIG. 11 is a schematic diagram explaining the display density values that are stored in the first frame memory 60 and the second frame memory 61.

FIG. 12 is a schematic diagram explaining the display density values that are stored in the first frame memory 60 and the second frame memory 61.

FIG. 13 is a diagram showing the construction of a display device according to a second embodiment of the present invention.

FIG. 14 is a flow chart explaining the control of the display controller 11 in the second embodiment of the present invention.

### DETAILED DESCRIPTIONS OF THE PREFERRED EMBODIMENTS

Some embodiments of the present invention will be explained in the following based on the drawings.

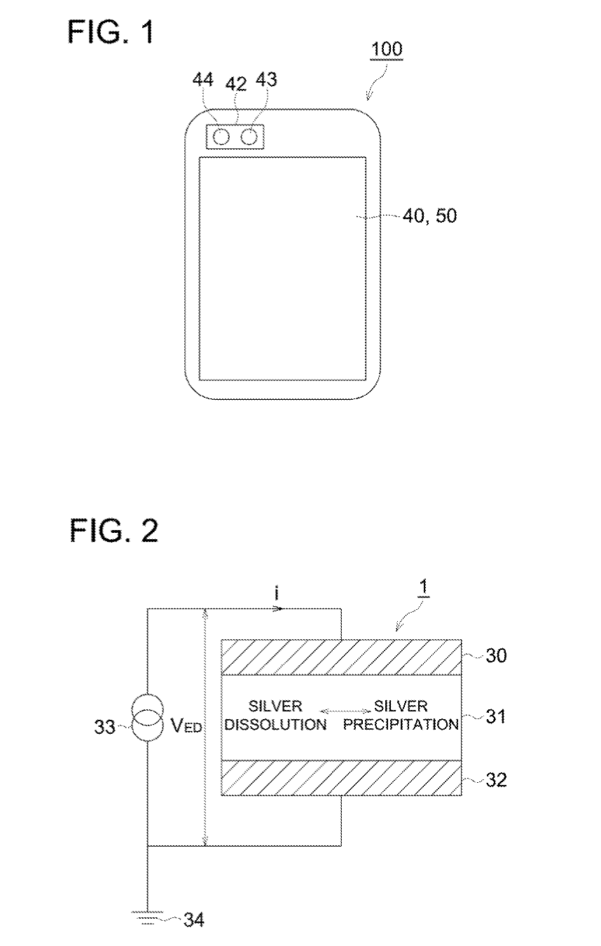

FIG. 1 is an external view showing an example of a display device according to a embodiment of the present invention.

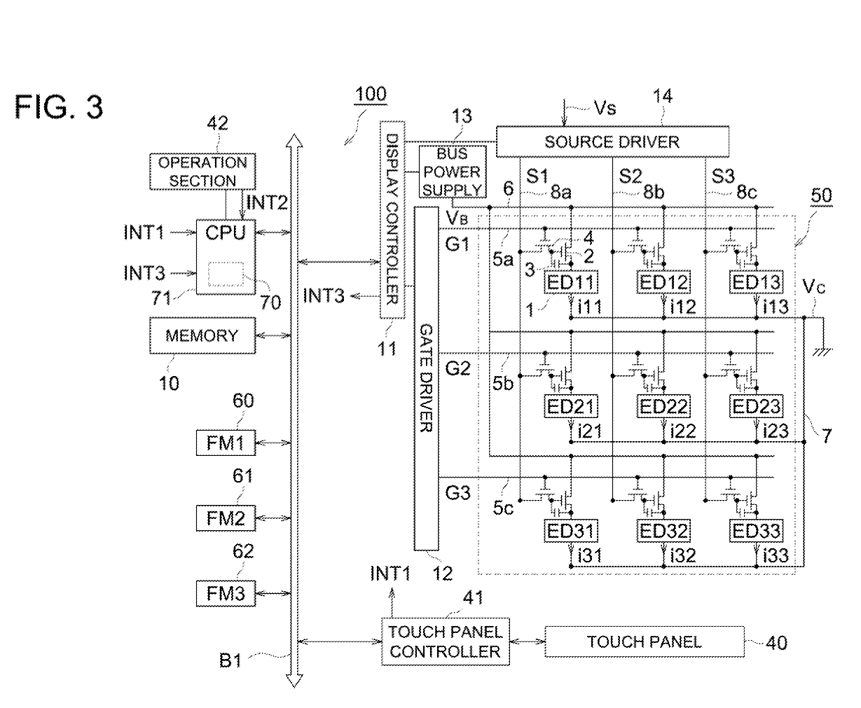

The display device 100 is, for example, an electronic book, and displays the data such as images, text characters, etc., stored in the storage section 10 (see FIG. 3) on the display screen 50. Electrochemical display elements 1 (see FIG. 2) having memory characteristics and capable to display black and white gray scale are used for the display screen 50. A next button 43 and a back button 44 are provided in the operation section 42 as mechanical switches. For example, when the user presses the next button 43, the data of the page following to the data that is currently being displayed on the display screen 50 is read out from the third frame memory 62, which will be explained later, and displayed. In a similar manner, when the user presses the hack button 44, the data of the page previous to the data that is currently being displayed on the display screen 50 is read out from the third frame memory 62 and displayed. Further, the display device 100 can be the display section of a tablet PC or a PDA, etc.

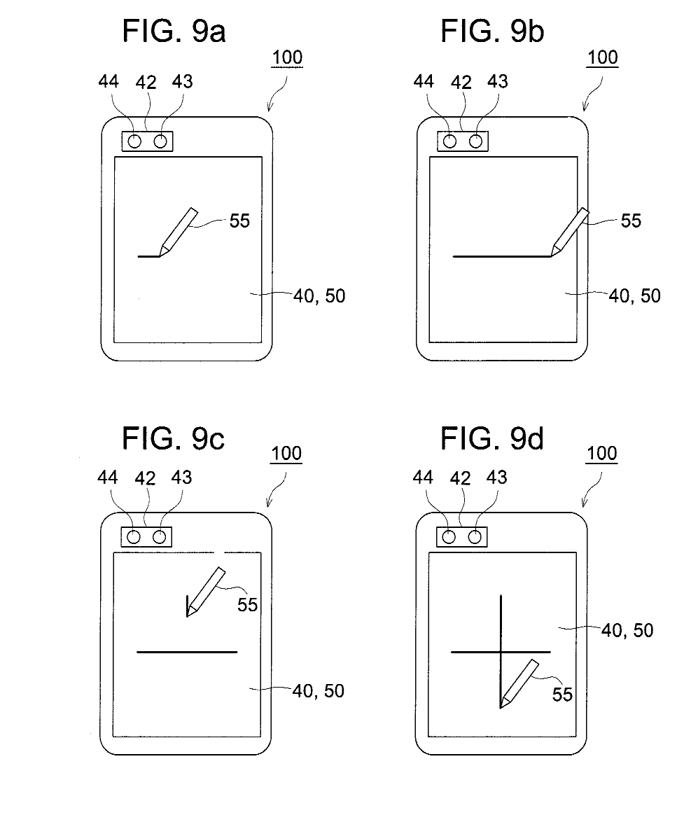

Further, the top layer of the display screen 50 is a touch panel 40 as an input section for inputting the location information on the screen. A user switches a mode to the handwriting mode by making input operations to the touch panel 40, and carries out handwriting input by specifying the position or the region on the screen. The input operation to the touch panel 40 can be made using a stylus pen 55 (see FIG. 9), or else, the touch panel 40 can be operated directly with a finger, etc.

FIG. 2 is an outline cross-sectional view showing the basic construction of one of electrochemical display elements 1 of the ED method used in a display device according to the present embodiment.

The electrochemical display element 1 holds an electrolyte 31 between a transparent ITO electrode 32 and a silver electrode 30. A current source 33 is connected to the ITO electrode 32 and the silver electrode 30. When a current “i” is applied flour the current source 33 to the silver electrode 30 in the direction of the arrow in the figure, a reduction reaction of silver ions in the electrolyte 31 takes place and silver is precipitated. Since the precipitated silver absorbs light, the density of the electrochemical element 1 as seen from the side of the ITO electrode 32 becomes high.

On the other hand, when a current “i” is applied from the current source 33 to the silver electrode 30 in a direction opposite to that of the arrow in the figure, an oxidization reaction takes place at the ITO electrode 32, and the precipitated silver becomes silver ion and dissolves into the electrolyte 31. If the current “i” is applied for a specific interval of time in a direction opposite to that of the arrow in the figure, the density of the electrochemical display element 1 as seen from the ITO electrode 32 side becomes white in color which is its initial state. Here, V_{ED} is the voltage between the ITO electrode 32 and the silver electrode 30 when the current “i” is applied.

The electrolyte 31 can be prepared, for example by inverting the phase of silver from an aqueous silver salt solution to a non-aqueous silver salt solution. This aqueous silver salt solution can be prepared by dissolving a publicly known silver salt in water.

FIG. 3 is a diagram showing the construction of a display device 100 according to the first embodiment of the present invention. Although in FIG. 3, 3 rows by 3 columns of pixels are shown to simplify the explanation, the display device 100 may have more number of pixels such as n rows by m columns.

Each pixel includes an electrochemical display element 1, a driving transistor 2, a supplementary capacitor 3 and a switching transistor 4. In FIG. 3, each electrochemical display element 1 of the nth row×mth column is denoted by EDnm. For example, the electrochemical display element of 1^{st} row and 1^{st} column is denoted by ED11, the electrochemical display element of 1^{st} row and 2^{nd} column is denoted by ED12, etc., successively. In addition, in FIG. 3, the case is shown in which the driving transistor 2 and the switching transistor 4 are constituted as N-channel TFTs.

The symbols 5a, 5b, and 5c denote scanning lines, which connect the gates of the switching transistors 4 of the pixels in the row direction are with each other, and they are connected to the gate driver 12. The symbols 8a, 8b, and 8c denote signal lines, which connect the sources of the switching transistors 4 along the column direction with each other, and they are connected to the source driver 14.

The gate driver 12 makes ON-OFF control of the switching transistors 4, by outputting the output voltages G1, G2, and G3 to the scanning lines 5a, 5b, and 5c, and selects the row to which the control voltage is to be applied.

The source driver 14 has driver circuits for each of the signal lines 8a, 8b, and 8c, and outputs the output voltages S1, S2, and S3 to the signal lines 8a, 8b, and/or 8c connected on the output side based on the control, of the display controller 11. The driver circuits of the source driver 14 are binary drivers having the values of ON and OFF, and outputs either the control voltage Vs input to the source driver 14 or the OFF voltage which is 0V based on the ON-OFF signals for each of the signal lines 8a, 8b, and 8c transmitted from the display controller 11.

The display controller 11 which includes a clock generator circuit and logic circuits, etc., controls the source driver 14, the gate driver 12, and the bus power supply 13, etc., at a prescribed frequency, and functions as a driver that applies current to the prescribed electrochemical display element 1.

The CPU 71 functions as a control section that controls the entire display device based on the programs stored in the storage section 10. The storage section 10 includes a recording medium such a ROM (Read Only Memory) or a flash memory, etc., and stores various types of programs and data that control the display device 100. The CPU 71 is provided with a comparison section 70 that successively compares the values of the display densities of the first frame memory 60 and the second frame memory 61, and suitably updates the values of the display densities stored respectively in the first frame memory 60 and the second frame memory 61.

The first frame memory 60 and the second frame memory 61 are frame memories of one screen respectively having storage areas corresponding to the number of pixels of the display screen 50. The first frame memory 60 stores the display density values X that have to be displayed next in the display screen 50 by the electrochemical display elements 1 (each pixel). The second frame memory 61 stores the display density values Y that are currently being displayed in the display screen 50 by the electrochemical display elements 1 (each pixel). The comparison section 70 reads the display density value X and the display density value Y of the corresponding pixel respectively from the first frame memory 60 and the second frame memory 61, and compares the two values.

The display controller 11 transmits the interrupt signal INT3 to the CPU 71 at the prescribed timing, and receives the result data of comparison carried out by the comparing section 70.

The third frame memory 62 has the capacity to store the image data (the display density values X) of a plurality of pages, and is configured so that the display density values X of the page specified by the operation section 42 is stored in the first frame memory 60. Further, in the figure, the first frame memory 60, the second frame memory 61, and the third frame memory 62 are indicated as FM1, FM2, and FM3, respectively.

A touch panel 40 is connected to a touch panel controller 41. The touch panel controller 41 successively scans the input regions of the touch panel 40, and when there is an input to the touch panel 40, it sends the interrupt signal INT1 to the CPU 71, and also transmits the information of the location where the input was made to the CPU 71.

When the next button 43 or the back button 44 constituted by mechanical switches is operated, the operation section 42 sends the interrupt signal INT2 to the CPU 71, and also transmits the information to the CPU 71 which button was operated.

The display controller 11, the CPU 71, the storage section 10, the first frame memory 60, the second frame memory 61, the third frame memory 62, and the touch panel controller 41, etc., are connected to the bus line B1 that includes the address bus and the data bus, and each connected element exchanges data via the bus line B1.

Since the circuit configurations of the respective pixels on the display screen 50 are the same, hereinafter, the pixel of the first row and first column will be explained as an example, using FIG. 3.

The drain of the driving transistor 2 is connected to the bus line 6, the source is connected to the silver electrode 30 of the electrochemical display element 1 (ED11). The supplementary capacitor 3 is connected between the source and the gate of the driving transistor 2 and retains the control voltage Vs applied between the source and the gate. The bus line 6 is connected to the bus power supply 13, and supplies the bus voltage V_{B} to the driving transistor 2. The driving transistor 2 applies a constant current to the electrochemical display element 1 according to the bus voltage V_{B} and the control voltage Vs applied between the gate and source.

The source of the switching transistor 4 is connected to the signal line 8a, the drain is connected to the supplementary capacitor 3 and the gate of the driving transistor 2, and the gate is connected to the gate driver 12. When the output voltage G1 of the gate driver 12 becomes ‘H’, the switching transistor 4 turns ON, and the output voltage S1 of the source driver 14 is applied to the gate and the supplementary capacitor 3 of the driving transistor 2.

The common electrode 7 is connected to the ITO electrodes 32 of the electrochemical display elements 1 of the respective pixels, and it is connected to GND at one end.

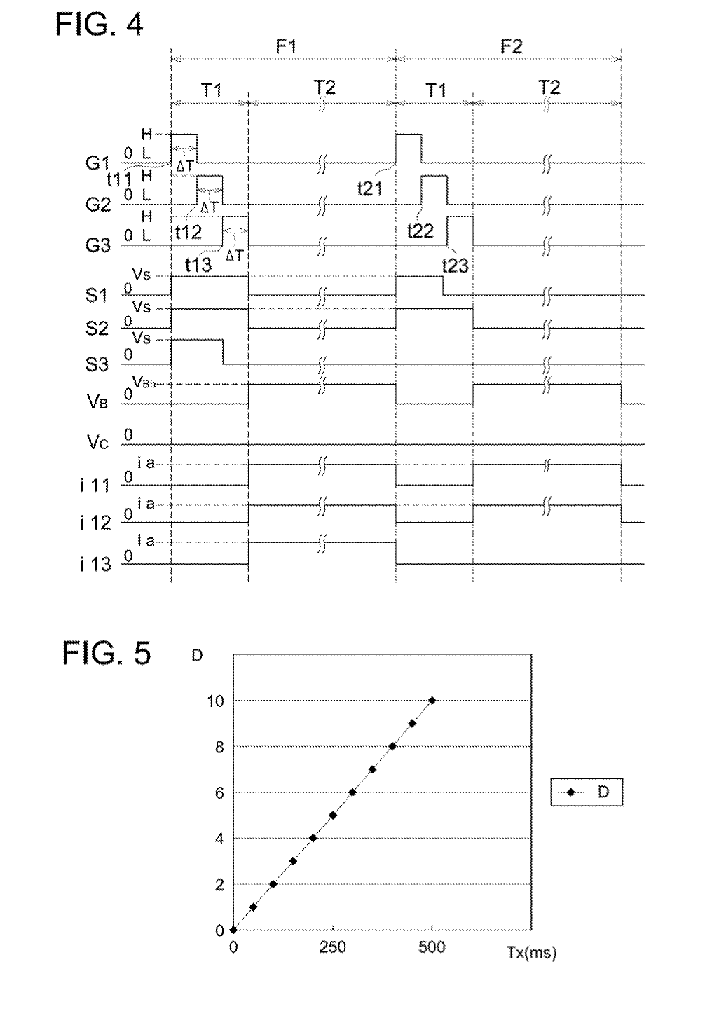

The writing operation of the display device of the present embodiment is explained below using FIG. 4 and FIG. 5.

FIG. 4 is a time chart showing the changes in the respective sections in one example during the writing operation of a display device according to the present embodiment, and FIG. 5 is a diagram explaining the display density D of a electrochemical display element 1 in the present embodiment. Further, in FIG. 4, for the sake of simplification, only the currents i11, i12, and i13 to the electrochemical display elements ED11, ED12, and ED13 are shown and the other currents are omitted.

The horizontal axis Tx of FIG. 5 shows the writing time, and the values 0 to 10 of the vertical axis show the display density values D. The value 0 indicates the minimum display density (white) of the electrochemical display element 1 and the value 10 indicates the maximum display density (black) of the electrochemical display element 1, and in the present embodiment, eleven gradations from 0 to 10 are to be displayed. As shown in FIG. 5, in the display element 1 of the present embodiment, the display density D increases according to the writing time Tx when a constant writing current is applied.

Next, the time chart of FIG. 4 will be explained. Further, in the present embodiment, before writing the image to the electrochemical display elements 1, currents have been applied in a direction opposite to that of the arrows shown by i11 to i33 in FIG. 3, and the images of all the pixels in electrochemical display elements 1 have been erased. In other words, before writing the image to the display element 1 in the time chart of FIG. 4, the display density values of all display elements 1 shall be 0.

T1 in FIG. 4 denotes the program interval during which the control voltages Vs of the driving transistors 2 of the respective pixels are set, and T2 denotes the writing interval which indicates the unit time of applying the writing currents i11 to i33 to the electrochemical display elements 1 of the respective pixels. The display device of the present embodiment obtains the desired display density D by carrying out the frame consisting of T1 and 12 multiple times.

F1 indicates the frame duration of the first frame and F2 indicates the frame duration of the second frame. The explanations are given starting from the program interval T1 of the first frame of FIG. 4.

During T1, V_{B} and V_{C} are 0V, and the currents i11 to i33 of the respective electrochemical display elements 1 are 0.

The display controller 11 transmits the interrupt signal INT3 to the CPU 71 at the timing of t₁₁, the beginning of the first frame, and requests the result data of comparison that the comparison section 70 has read out from the first frame memory 60 and the second frame memory 61 the display density value X and the display density values Y, respectively, of the pixels of the first row and compares them.

When the CPU 71 receives the interrupt signal INT3, it carries out interrupt processing, described in detail later, and transmits the result data of comparison of the first row compared by the comparison section 70 to the display controller 11. The display controller 11 controls the source driver 14, turns ON the signal lines 8 corresponding to the pixels for which the comparing section 70 determined as X>Y, and turns OFF the signal lines 8 corresponding to all other pixels.

The example in FIG. 4 shows the case that the result of comparison made by the comparison section 70 in the first row is X>Y for all the pixels, and the display controller 11 has turned ON all the signal lines 8a, 8b, and 8c. The output voltage G1 of the gate driver 12 for the first row rises from to ‘H’ at the timing t₁₁ and keeps ‘H’ for a period of ΔT. During this period, the output voltages G2 and G3 are ‘L’.

The output voltages S1, S2, and S3 of the source driver 14 are Vs, and the voltage between the gate and the source of the driving transistors 2 connected to ED11, ED12, and ED13 of the first row is set to Vs which is retained by the supplementary capacitor 3.

Next, the display controller 11 sends the interrupt signal INT3 to the CPU 71 at the timing t₁₂ and requests the result data of comparison of the second row from the comparing section 70. The display controller 11 similarly controls the source driver 14, and turns ON the signal lines 8 corresponding to the pixels for which the comparing section 70 determined that X>Y, and turns OFF the signal lines 8 corresponding to all other pixels.

The example in FIG. 4 shows the case that the result of comparison made by the comparison section 70 in the second row is X>Y in all the pixels, and the display controller 11 has turned ON all the signal lines 8; 8b, and 8c. The output voltage G2 of the gate driver 12 for the second row rises from ‘L’ to ‘H’ at the timing t₁₂ and becomes ‘H’ for a period of ΔT. During this period, the output voltages G1 and G3 are ‘L’.

The output voltages S1, S2, and S3 of the source driver 14 are Vs, and the voltage between the gate and source of the driving transistors 2 connected to ED21, ED22, and ED23 of the second row is set to Vs which is retained by the supplementary capacitor 3.

Next, the display controller 11 sends the interrupt signal INT3 to the CPU 71 at the timing t₁₃ and requests the result data of comparison of the third row from the comparing section 70. The display controller 11 similarly controls the source driver 14, turns ON the signal lines 8 corresponding to the pixels for which the comparing section 70 determined that X>Y, and turns OFF the signal lines 8 corresponding to all other pixels.

The example in FIG. 4 shows the case in which the result of comparison made by the comparison section 70 for the third row is X>Y for ED31 and ED32 and is X≦Y for ED33, and based on this, the display controller 11 has turned ON the signal lines 8a and 8b, and has turned OFF the signal line 8c. The output voltage G3 of the gate driver 12 for the third row rises from ‘L’ to ‘H’ at the timing t₁₃ and becomes ‘H’ for a period of ΔT. During this period, the output voltages G1 and G2 are ‘L’.

Therefore, the output voltages S1 and S2 of the source driver 14 is Vs and the voltages between the gate and source of the driving transistors 2 connected to ED31 and ED32 in the third row are set to Vs which is retained by the supplementary capacitors 3. Further, during this period, the output voltage S3 is 0, and the voltage between the gate and the source of the driving transistor 2 connected to ED33 is set to 0V that is retained by the supplementary capacitor 3.

During the next T2 writing interval, the display controller 11 changes the output voltage V_{B} of the bus power supply 13 from 0 to V_{Bh}. When the output voltage V_{B} becomes V_{Bh}, the driving transistor 2 applies a constant current to the electrochemical display elements 1 according to the voltage between the gate and the source of the driving transistor 2, and said voltage is being retained by the supplementary capacitor 3.

In the example shown in FIG. 4, during the above period, the current values of the currents i11, i12, and i13 flowing through ED11, ED12, and ED13 are “ia”. In the above example, although the current i33 of the electrochemical display element 1 of ED33, not shown in FIG. 4, is 0, the current values of all other electrochemical display elements 1 are “ia”. In this manner, a writing current “ia” is applied to the pixels for which the comparing section 70 determined that X>Y.

Similarly, even during the program interval T1 of the second frame F2, the display controller 11 transmits the interrupt signal INT3 to the CPU 71 at the timing t₂₁, and requests the result of comparison in the first row carried out by the comparing section 70. Similarly, the display controller 11 controls the source driver 14, and turns ON the signal line 8 corresponding to the pixels for which the comparing section 70 determined that X>Y, and turns OFF the signal lines 8 of all other pixels.

The example in FIG. 4 shows the one in which the result of determination by the comparing section 70 for the fast row is that X>Y for ED11 and ED12 and is X≦Y for ED13, and based on this, the display controller 11 has turned ON the signal lines 8a and 8b, and turned OFF the signal line 8c. The output voltage G1 of the gate driver 12 for the first row rises from ‘L’ to ‘H’ at the timing t₂₁ and becomes ‘H’ for a period of ΔT. During this period, G2 and G3 will be ‘L’.

Therefore, the output voltages S1 and S2 of the source driver 14 is Vs, and the voltages between the gate and the source of the driving transistors 2 connected to ED11 and ED12 are set to Vs that are retained by the supplementary capacitors 3. Further, during this period, the output voltage S3 is 0, and the voltage between the gate and source of the driving transistor 2 connected to ED13 is set to 0V that is retained by the supplementary capacitor 3.

Thereafter, the display controller 11 transmits the interrupt signal INT3 to the CPU 71 at the timing t₂₂ and the timing t₂₃, and similar processing is made.

During the writing interval T2, a constant current is applied to the electrochemical display elements 1 according to the voltage between the gate and the source of the driving transistors 2 which was retained by the supplementary capacitors 3 during the interval T1. The example in FIG. 4 shows that the current values i11 and i12 of ED11 and ED12 during this period are “ia”, and the current value i13 of ED13 is 0.

When a current with a current value of “ia” is applied to the electrochemical display element 1 during the interval T2, the display density D of the electrochemical display element increases by 1. For example, when writing for one frame is carried out to an electrochemical display element 1, which display density is 0, the display density becomes 1.

In FIG. 4, although up to the second frame have only been illustrated, in order to write up to the maximum display density 10, the frame for writing is repeated 10 times. Therefore, if writing of 10 frames is made to an electrochemical display element 1 which display density is 0, it is possible to make that electrochemical display element 1 have the maximum display density 10.

Further, since the display density D changes according to the integrated value of the writing current, it is not necessary to carry out the writing by successive frames. In addition, while the 11-step gradation from 0 to 10 is used in the present embodiment, it is also possible to use still more steps, or to use fewer steps of gradation by suitably setting the value of the writing current “ia” and the writing interval.

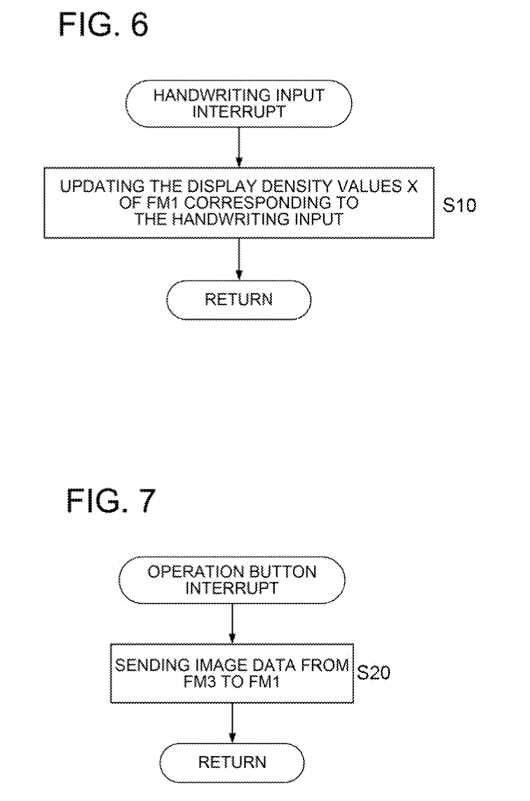

Next, the control procedure of the display device 100 in the present embodiment will be explained using the flow charts of FIG. 6 to FIG. 8.

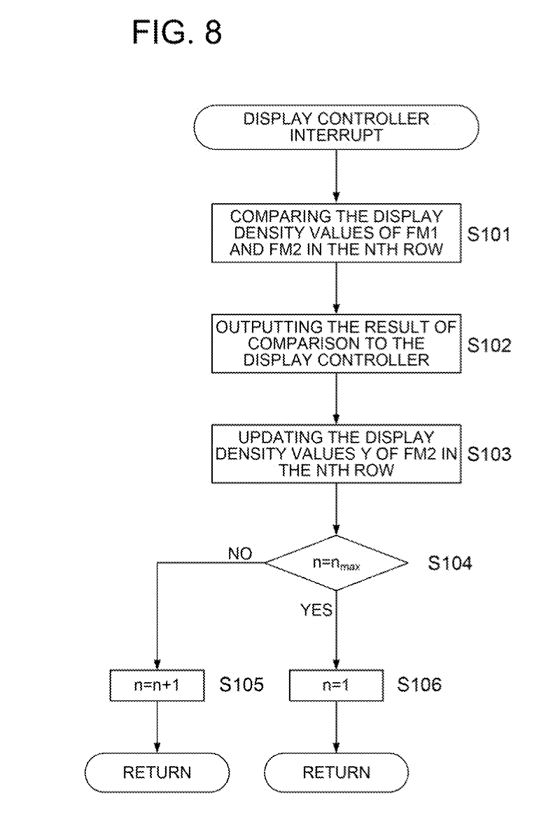

FIG. 6 is a flow chart explaining the interrupt servicing by a handwriting input in the present embodiment, and FIG. 7 is a flow chart explaining the interrupt servicing by an operation button in the present embodiment FIG. 8 is a flow chart explaining the interrupt servicing by the display controller 11 in the present embodiment.

The flow chart of FIG. 6 will be explained first.

When an input is made using a stylus pen 55, etc., on the touch panel 40, an interrupt signal INT1 is transmitted from the touch panel controller 41 to the CPU 71, and the handwriting input interrupt servicing routine shown in FIG. 6 is started in the CPU 71.

The Step S10 is executed in the handwriting input interrupt servicing routine.

S10: This is the step in which the CPU 71 updates the display density value X of the first frame memory 60 corresponding to the handwriting input.

The CPU 71 updates the display density value X stored in the first frame memory 60 based on the location information detected by the touch panel controller 41. In the present embodiment, the CPU 71 updates the display density value X stored in the first frame memory 60 at the address corresponding to the location information detected by the touch panel controller 41 to the maximum display density 10.

When the interrupt servicing ends, the processing by the CPU 71 returns to the source routine.

That is all of the explanation regarding the handwriting input interrupt servicing routine.

Next, the flow chart of FIG. 7 will be explained.

When the operator presses the next button 43 or the back button 44 of the operation section 42, the interrupt signal INT2 is transmitted from the operation section 42 to the CPU 71, and the CPU 71 starts the operation button interrupt servicing routine shown in FIG. 6.

In the operation button interrupt servicing routine, the Step S20 is executed.

S20: When the operation of either the next button 43 or the back button 44 is detected, the CPU 71 reads out the image data of the corresponding page from the third frame memory 62 as well as initializing the display screen, and writes the display density values X of that page in the first frame memory 60.

For example, when the operator presses the next button 43 in the operation section 42 in the state that the first page is being displayed, the CPU 71 reads out the image data of the second page from the third frame memory 62 and writes the image data (the display density values X) in the first frame memory 60.

When the interrupt servicing ends, the processing by the CPU returns to the source routine.

The above is the explanation of the operation button interrupt servicing routine.

Next, the flow chart of FIG. 8 will be explained.

The interrupt signal INT3 is transmitted from the display controller 11 at the rising edge of Gn of each frame as explained in FIG. 4, and the display controller interrupt servicing routine shown in FIG. 8 is started by the CPU 71. Further, in the initial state such as a power-on state, the value is initialized as n=1.

S101: This is the step of comparing the values of the display densities of the first frame memory 60 and the second frame memory 61 for the nth line.

The comparison section 70 successively reads and compares the display density values X stored in the first frame memory 60 and the display density values Y stored in the second frame memory 61 along the row direction for the nth row, and determines the result as ‘H’ when Xnm>Ynm, and determines the result as ‘L’ when Xnm≦Ynm. The comparison section 70 temporarily stores the determined results in the storage section 10.

For example, in the case of the first column of the first row, if it is considered that X₁₁ is 10 and Y₁₁ is 0, the determined result is ‘H’, and this result is temporarily stored in the storage section 10.

S102: This is the step of outputting to the display controller 11 the result of comparison made in Step S101.

The CPU 71 outputs the result of comparison made in Step S101 and temporarily stored in the storage section 10 to the display controller 11. The display controller 11 turns ON the driver circuit of the source driver 14 for which the result was determined as ‘H’, and turns OFF the driver circuit of the source driver 14 for which the result was determined as ‘L’.

S103: This is the step of updating the display density values Y of the nth row in the second frame memory 61.

The display controller 11 increases the display density values Y of the pixels of the nth row in the second frame memory 61 corresponding to the writing current. For example, if the display density value is 0, the display density value Y₁₁ will be updated to 1.

S104: This is the step of comparing n and

The CPU 71 compares n with the final row, of the display device.

When n≠nₘₐₓ (NO in Step S104), the processing proceeds to Step S105.

S105: This is the step of making n=n+1.

The value of n is incremented to n+1 if the comparison has not been completed up to the final row nₘₐₓ, and the processing returns to the source routine.

For example, if n is 1, n is updated to 2, and when the interrupt signal INT3 is transmitted from the display controller 11 next, the display density of the second row will be compared in this routine.

When n=nₘₐₓ (YES in Step S104), the processing proceeds to Step S106.

S106: This is the step of making n=1.

Since the comparison was done up to the final row, n is set to n=1 and the processing returns to the source routine.

When the interrupt signal INT3 is transmitted from the display controller 11 next, the processing of the next frame is to be done, and the comparison of the display density is started from the first row in this routine.

The above is the explanation of the display controller interrupt servicing routine.

Next, the processings of the display device explained so far will be detailed based on a concrete example using FIG. 9 to FIG. 12.

FIG. 9 is an explanatory diagram explaining one example of the handwriting input operation in the display device 100.

FIG. 9 illustrates the procedure of writing a cross line on the touch panel 40 using a stylus pen 55. In FIG. 9, in order to make the explanation simple, an example that a cross line is written by handwriting input on the display screen 50 on which an entirely white area is being displayed. The procedure is same as the case of overwriting the images and/or letters by handwriting input on the display 50 where the images and/or letters are being displayed.

FIG. 9a shows the position of the stylus pen 55 at the time immediately after starting to write a horizontal line by handwriting input, and FIG. 9b shows the position at which the writing of the horizontal line is ended. In addition, FIG. 9c shows the position at the time immediately after starting to write a vertical line, and FIG. 9d shows the position at which the writing of the vertical line is ended.

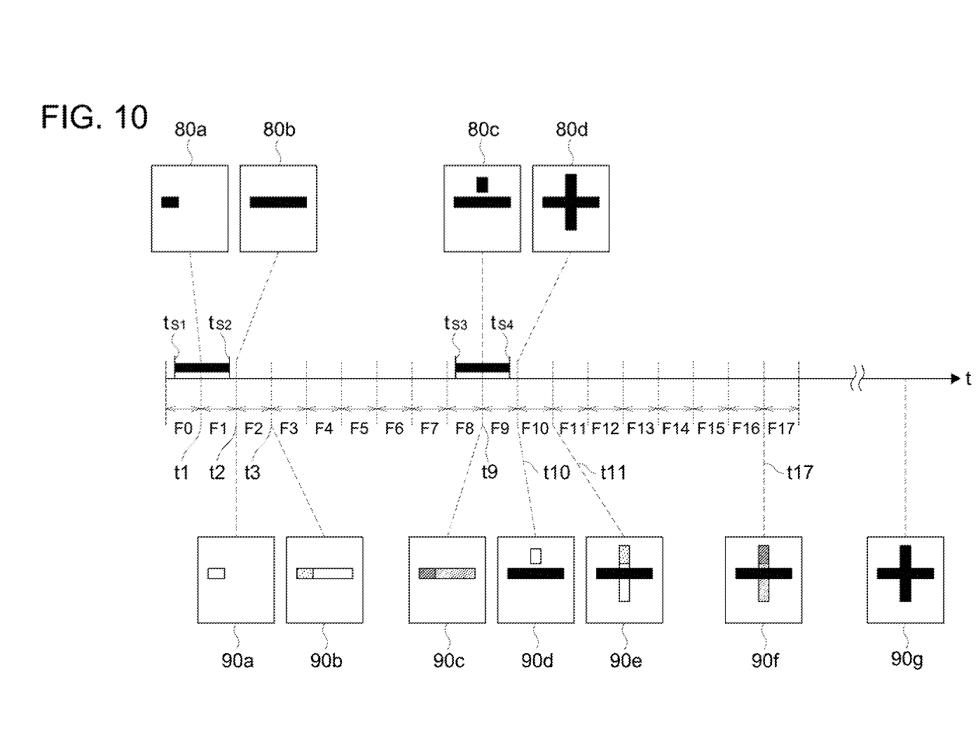

The lines shown in FIG. 9 indicate the path of the stylus pen 55. he display density actually displayed will be explained next using FIG. 10 to FIG. 12.

FIG. 10 is a time chart schematically showing the display density X and the display density Y stored in the first frame memory 60 and the second frame memory 61 in time series when a cross line is input by handwriting as shown in FIG. 9.

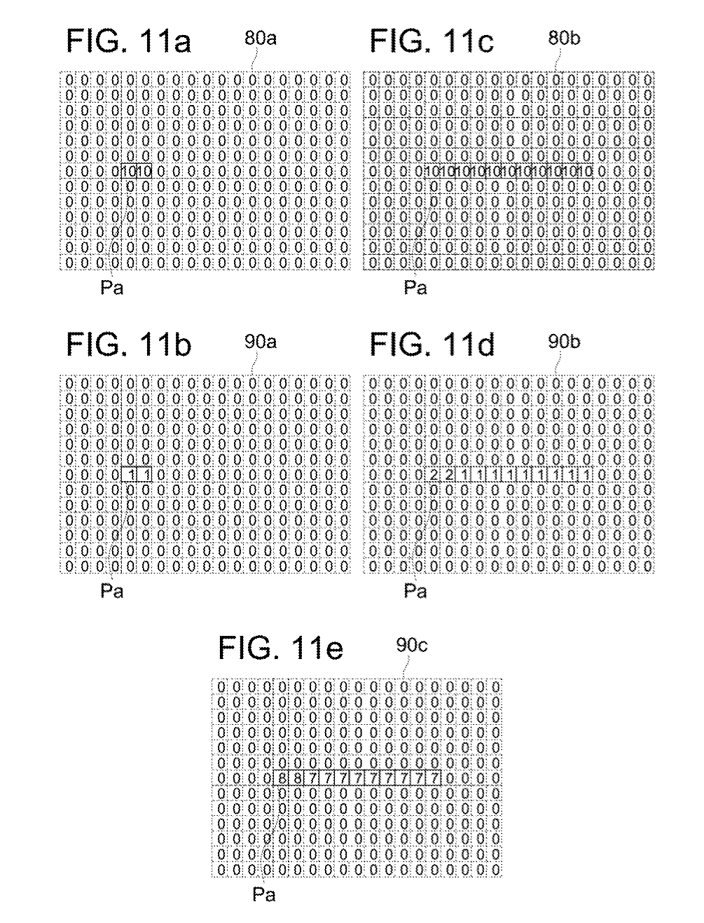

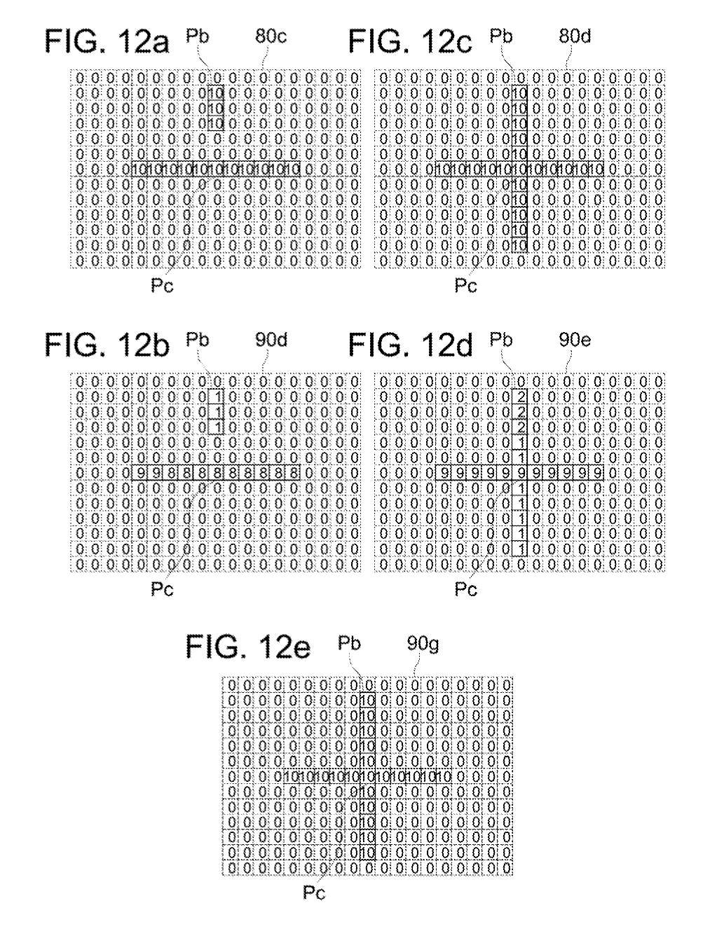

FIG. 11 and FIG. 12 are schematic diagrams explaining the values of the display density X and the display density Y stored in the first frame memory 60 and the second frame memory 61. The dotted grid lines shown in FIG. 11 and FIG. 12 respectively indicate the pixels of the display screen 50, and the numbers in the grid boxes indicate the display density values X and the display density values Y stored in the respective frame memories corresponding to that pixel.

The F0 to F17 shown along the time axis in FIG. 10 respectively denote the frame intervals explained in FIG. 4. The display controller 11 is carrying out the frame processing in this manner at a constant frequency. Here, tₛ₁ is the timing that the stylus pen 55 contacts on the touch panel 40 and starts to write the horizontal line, and tₛ₂ is the timing that the stylus pen 55 is removed from the touch panel 40 after finishing the writing of the horizontal line. Further, tₛ₃ is the timing that the stylus pen 55 contacts on the touch panel 40 and starts to write the vertical line, and tₛ₄ is the timing that the stylus pen 55 is removed from the touch panel 40 after finishing the writing of the vertical line. In this manner, handwriting input is carried out independently of the frame processing cycle.

Further, t1 is the timing that the first frame starts, and the program interval T1 described in FIG. 4 starts from t1. In a similar manner, t2 to t17 denote the starting timings of the second frame to the 17^{th} frame, respectively.

80a, 80b, 80c, and 80c1 in FIG. 10 are depicted according to the display density values X stored in the first frame memory 60 corresponding to 80a, 80b, 80c and 80d shown in FIG. 11 and FIG. 12, for example, the display density value 0 is expressed as white, and the display density value of 10 is expressed as black.

Further, 90a, 90b, 90c, 90d, 90; and 90g in FIG. 10 are depicted according to the display density values Y stored in the second frame memory 61 corresponding to 90a, 90b, 90c, 90d, 90e and 90g shown in FIG. 11 and FIG. 12, for example, the display density value 0 is expressed as white, and the display density value 10 is expressed as black.

The explanations will be given sequentially along the time axis of FIG. 10 below.

At the timing tₛ₁, the interrupt signal INT1 is transmitted from the touch panel controller 41 to the CPU 71, and the handwriting input interrupt servicing routine shown in FIG. 6 is activated by the CPU 71, and the display density values X of the first frame memory 60 at the address corresponding to the position of the handwriting input are successively updated to 10.

80a shows the display density value X of the first frame memory 60 at the instant of time t1 In other words, as shown in FIG. 11, the display density value X of the pixel Pa and the pixel to its right is 10, and the display density value X is 0 of all other pixels is 0.

Further, the display density values Y of the display density of the second frame memory 61 at the instant of time t1 are all 0 although they are not shown in the figure.

In the first frame that starts from the timing t1, the interrupt signal INT3 is transmitted to the CPU 71 periodically at every rising edge of Gn from the display controller 11 during the program interval T1, and the CPU 71 executes the display controller interrupt servicing routine.

In the display controller interrupt servicing routine, as explained in FIG. 8, the comparison section 70 successively reads out and compares the display density values X stored in the first frame memory 60 and the display density values Y stored in the second frame memory 61, respectively, of the nth row in the row direction, and determines the result as ‘H’ when Xnm>Ynm and as ‘L’ when Xnm≦Ynm. The display density value X of the pixel Pa and the pixel to its right in the first frame memory 60 is 10, and display density value Y in the second frame memory 61 corresponding to the said pixels is 0, and after the display controller interrupt servicing routine ended, writing currents are applied to the electrochemical display elements 1 corresponding to these two pixels. On the other hand, no writing current is applied to the electrochemical display elements 1 corresponding to all other pixels.

The electrochemical element 1, to which a writing current was applied, gradually increases the density, and when the writing interval T2 ends, a horizontal line with a display density value 1 is displayed at positions corresponding to the pixel indicated as Pa and the pixel to its right on the display screen 50.

Further, in the Step S103 of the display controller interrupt servicing routine, the CPU 71 increases the display density values Y to 1 in the second frame memory 61 at positions corresponding to the pixel indicated by Pa and the pixel to its right, and at the timing t2, the state will be as shown in FIG. 11b.

On the other hand, at the timing t2, the writing of the horizontal line by the stylus pen 55 has been completed, and the display density values X stored in the first frame memory 60 have become 10 corresponding to the position from the pixel indicated by Pa to the 10^{th} pixels to the right as shown in FIG. 11c.

Similar to the first frame, even during the second frame the CPU 71 executes the display controller interrupt servicing routine, and the display controller 11 applies a writing current to the electrochemical display elements 1 corresponding to the pixels for which X>Y.

Going through a processing similar to the first frame, the display density values Y of the second frame memory 61 corresponding to the pixels where writing current was applied have increased at the timing t3 as shown in FIG. 11d. Since writing current was applied to the pixel indicated by Pa and the pixel to its right twice, the display density value Y has become 2, and the display density value Y at the pixels on which the writing current was applied during the second frame has become 1.

In the succeeding frames, writing current is applied to the corresponding electrochemical display elements 1 until X becomes equal to Y and the display density of such portion will gradually increase the density on the display screen 50. For example, at the timing t9, the display density has become high as shown in FIG. 11e.

In this manner, in the present embodiment, since the information of the handwriting is displayed lightly immediately after the handwriting input, and the display density is gradually increased, thus handwriting input can be displayed at a practicable speed.

Similarly, when a vertical line is written at the timing of tₛ₃, the interrupt signal INT1 is transmitted from the touch panel controller 41 to the CPU 71, the handwriting input interrupt servicing routine shown in FIG. 6 is started by the CPU 71, and the display density values X of the first frame memory 60 at the address corresponding to the position of the handwriting input are successively updated.

80c shows the display density value X of the first frame memory 60 at the instant of time t9. In other words, the display density value X is 10 at the pixels where the horizontal line has been written and from the pixel indicated by Pb to the position that two pixels below as shown in FIG. 12a, and the display density value X of all other pixels excepting the pixels where the horizontal line has been written is 0.

Similar to the explanations given so far, in the ninth frame the CPU 71 executes the display controller interrupt servicing routine, and applies writing currents to the electrochemical display elements 1 corresponding to the pixels with X>Y.

By a similar processing, the pixels of the second frame memory 61 will be shown in FIG. 12b at the timing t10. Since writing has been done once for the pixel indicated by Pb and two pixels below it, the display density value Y is 1, and the pixels of the horizontal line will have the display density values according to the number of times they have been written. In this manner in the present invention, even at the time of additional writing to the pixels of the horizontal line, it is possible to display the vertical line that has been newly input by handwriting input.

In the succeeding frames, writing currents are applied to the corresponding electrochemical display elements 1 until X becomes equal to Y and the written image gradually increases the display density on the display screen. For example, at the timing t11, the display density is as shown in FIG. 12d.

In this manner, writing currents are added in the pixels for which X>Y at every frame the display density value Y of the pixels of the horizontal line and the vertical line become 10 as shown in FIG. 12e, and these pixels are displayed with the maximum display density on the display screen 50. In the present embodiment, at the time of applying the writing current, X becomes equal to Y at positions where the display density value Y has become already 10 at the time of writing the vertical line, such as the pixel indicated by Pc at the position where the vertical line and the horizontal line intersect each other, and hence no writing current will be applied. Therefore, since writing current is not applied to exceeds the maximum display density, there will be no occurrence of problems such as the case displayed image becomes difficult to be erased when the erasing voltage is applied, or the displayed image getting burnt on to the display device.

Further, in the present embodiment, although an example was explained here in which the part where the handwriting input was displayed in black color with the maximum display density 10, it is also possible to display in white color with the minimum display density of 0. (When the background is black, it is desirable to display in white color.) To reduce the display density of the electrochemical display element 1, it is sufficient to reverse the polarities of the common voltage Vc and the control voltage Vs so that the current in the electrochemical display element 1 flows in a direction opposite to that shown in FIG. 3; and the display controller 11 applies current to the electrochemical display elements 1 corresponding to the pixels with X<Y.

Next, a display device according to a second preferred embodiment will be explained.

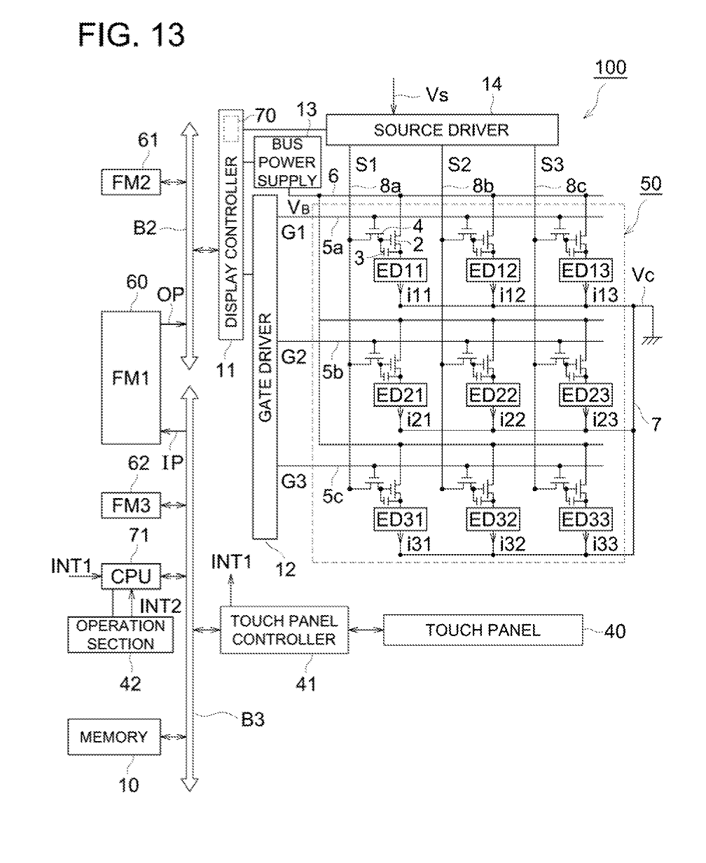

FIG. 13 is a diagram showing the configuration of a display device according to a second embodiment of the present invention. In FIG. 13, similar to the first embodiment, 3 rows by 3 columns of pixels have been shown to simplify the explanations, the display device may also have more number of pixels such as n rows by m columns.

The biggest difference between the first embodiment and the second embodiment is that a FIFO memory is used for the first frame memory 60. In the present embodiment, two bus lines are provided i.e. the bus line B2 to which the display controller 11 and the second frame memory 61 are connected, and the bus line B3 to which the CPU 71 and the third frame memory 62, the touch panel controller 41, the storage section 10, etc., are connected. The input port IP of the first frame memory 60 is connected to the bus line B3, and its output port OP is connected to the bus line B2. The image data of one row input by the CPU 71 through the input port IP is read out successively from the output port OP by the display controller 11 via the bus line B2.

In the present embodiment, the data input from the CPU 71 and the data read out by the display controller 11 are made asynchronously, and it is not necessary to adjust the timing by the interrupt signal INT3 as in the first embodiment.

By having this type of configuration, since the writing to and the reading from the first frame memory 60 are carried out using different bus lines respectively, there is no bus line contention, and the display controller 11 can read out the image data from the first frame memory 60 at the prescribed timings without any delay.

The display controller 11 of the present embodiment has, for example, a clock generator circuit, a CPU, memory, and logic circuits, etc., and has a comparison section 70.

Other configuration and the configuration elements are similar to the first embodiment, and the same reference numbers are denoted to the respective configuration elements and their explanations are omitted here.

Next, the control carried out by the display controller 11 in the present embodiment will be explained.

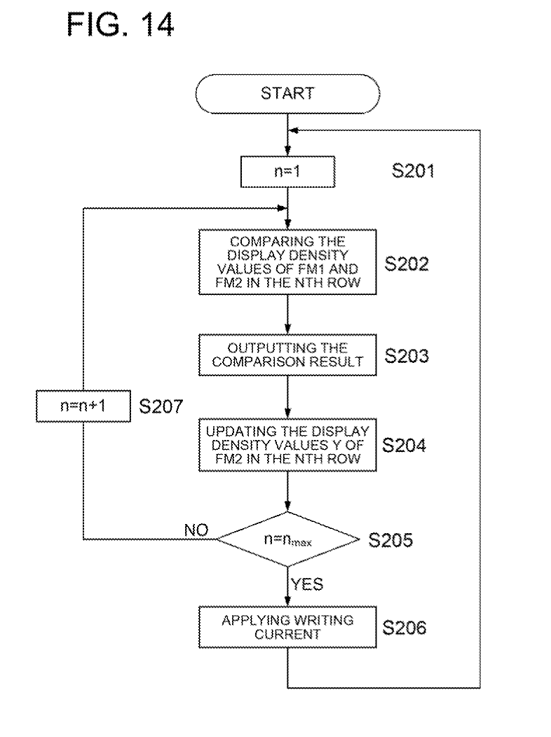

FIG. 14 is a flow chart explaining the control performed by the display controller 11 in the second embodiment of the present invention.

In the second embodiment, the display controller 11 executes the procedure according to the flow chart shown in FIG. 14 asynchronously with the CPU 71, and the time chart explained in FIG. 4 is realized.

S201: This is the step of setting n=1.

The display controller 11 initializes n to n=1.

S202: This is the step of comparing the display density values of the first frame memory 60 and the second frame memory 61 as to the nth row.

The comparison section 70 successively reads and compares the display density values X stored in the first frame memory 60 and the display density values Y stored in the second frame memory 61, respectively, of the nth row in the row direction, and determines the result as ‘H’ when Xnm>Ynm and as ‘L’ when Xnm≦Ynm. The comparison section 70 temporarily stores the result of determination in the memory of the display controller 11.

For example, in the case of the first column of the first row, if it is considered that X₁₁ is 10 and Y₁₁ is 0, the determined result will be ‘H’, and a writing electric current is applied to the electrochemical display element 1 of the first column of the first row in the subsequent processing.

S203: This is the step of outputting the result of comparison made in Step S101 to the source driver 14.

The CPU 71 outputs to the source driver 14 the result of comparison made in Step S102 and stored temporarily in the memory of the display controller 11. The display controller 11 turns ON the driver circuit of the source driver 14 for which the determination of ‘H’ has been made, and turns OFF the driver circuit of the source driver 14 for which the determination of ‘L’ has been made.

S204: This is the step of updating the display density values Y of the nth line of the second frame memory 61.

The display controller 11 updates the display density values Y corresponding to the pixels of the nth row of the second frame memory 61. For example, if the display density value Y₁₁ of the first column of the first row was 0, it is updated to 1.

S205: This is the step of comparing n and nₘₐₓ.

The display controller 11 compares the value n with the value of the final row nₘₐₓ of the display device.

When n≠nₘₐₓ (NO in Step S205), the processing proceeds to Step S207.

S207: This is the step of making n=n+1.

The value of n is incremented to n+1 since the comparison is not completed up to the final row nₘₐₓ, and the processing returns to Step S202.

When n=nₘₐₓ (YES in Step S205), the processing proceeds to Step S206.

S206: This is the step of applying writing current.

The display controller 11 instructs the bus power supply 13 to output V_{Bh}, and after waiting for the duration of T2, the processing returns to Step S201.

In this manner, the writing to the electrochemical display element 1 is repeated at a constant frequency.

The above is the explanation of the control routine of the display controller 11.

Although an example using software control was explained in the present embodiment, it is also possible to configure the display controller 11 using only hardware logic so that a similar procedure will be realized

Further, in the present embodiment, although an ED type was used for the electrochemical display elements 1, it is also possible to use other types such as the electro-chromic type, etc., as long as it is a display element having memory characteristics which display density changes with the application of an electric current.

In addition, in the present embodiment, although a touch panel 40 was used as the input section for inputting the location information on the top layer of the display screen 50, it is also possible to use other configurations such as, for example, identifying the location information on the display screen 50 by taking an image of a stylus pen 55 optically, etc.

In the above manner, according to the present invention, it is possible to provide a reflection type display device that can carry out handwriting display at a practicable speed irrespective of the timing of the handwriting input and without losing the display characteristics of the electrochemical display elements.

### DESCRIPTIONS OF SYMBOLS

1 Electrochemical display element
2 Driving transistor
3 Supplementary capacitor
4 Switching transistor
5a, 5b, 5c Scanning lines
8a, 8b, 8c Signal lines
10 Storage section
11 Display controller
12 Gate driver
13 Bus power supply
14 Source driver
30 Silver electrode
31 Electrolyte
32 ITO electrode
40 Touch panel
41 Touch panel controller
60 First frame memory
61 Second frame memory
62 Third frame memory
70 Comparison section
71 CPU

1.-5. (canceled)

6. A display device comprising:
a display screen having matrix-arranged electrochemical display elements, wherein an electric current is applied to an electrochemical display element according to a display density to be displayed in the electrochemical display element, to display an image;
a first memory configured to store display density values X to be displayed next respectively in each electrochemical display element;
a second memory configured to store display density values Y being currently displayed respectively in each electrochemical display element;
an input section which obtains location information of a user input on the display screen;
a first updating section for updating the display density value X which is being stored in the first memory, whereby the display density value X of the electrochemical display element corresponding to location information which has been obtained by the input section is updated;
a comparison section which compares the display density value X stored in the first memory with the display density value Y of the corresponding electrochemical display element stored in the second memory;
a driver for applying a writing current to each electrochemical display element based on a result of the comparison by the comparison section; and,
a second updating section for updating the display density value Y which is being stored in the second memory along with the application of the writing current by the driver.

7. The display device of claim 6, further comprising a third memory configured to store the display density values X for a plurality of pages to be stored in the first memory.

8. The display device of claim 6, wherein the input section is a touch panel provided in the top layer of the display screen.

9. The display device of claim 7, wherein the input section is a touch panel provided in the top layer of the display screen.

10. A display device comprising:
a display screen having matrix-arranged electrochemical display elements, wherein an electric current is applied to an electrochemical display element according to a display density to be displayed in the electrochemical display element, to display an image;
a first memory configured to store display density values X to be displayed next respectively in each electrochemical display element;
a second memory configured to store display density values Y being currently displayed respectively in each electrochemical display element;
an input section which obtains location information of a user input on the display screen;
a first updating section for updating the display density value X which is being stored in the first memory, whereby the display density value X of the electrochemical display element corresponding to location information which has been obtained by the input section is updated;
a comparison section which compares the display density value X stored in the first memory with the display density value Y of the corresponding electrochemical display element stored in the second memory;
a driver for applying a writing current to each electrochemical display element based on a result of the comparison by the comparison section, wherein the writing current is applied to the electrochemical display element for which the comparison section has determined that the display density value X is larger than the display density value Y; and,
a second updating section for updating the display density value Y which is being stored in the second memory along with the application of the writing current by the driver.

11. The display device of claim 10, further comprising a third memory configured to store the display density values X for a plurality of pages to be stored in the first memory.

12. The display device of claim 10, wherein the first memory is a FIFO memory, and the updating of the display density value X which is being stored in the first memory by the first updating section and the comparison of the display density value X and the display density value Y by the comparison section are performed asynchronously.

13. The display device of claim 10, wherein the input section is a touch panel provided in the top layer of the display screen.

14. The display device of claim 11, wherein the first memory is a FIFO memory, and the updating of the display density value X which is being stored in the first memory by the first updating section and the comparison of the display density value X and the display density value Y by the comparison section are performed asynchronously.

15. The display device of claim 11, wherein the input section is a touch panel provided in the top layer of the display screen.

16. The display device of claim 12, wherein the input section is a touch panel provided in the top layer of the display screen.

17. The display device of claim 14, wherein the input section is a touch panel provided in the top layer of the display screen.

18. A display device comprising:
a display screen having matrix-arranged electrochemical display elements, wherein an electric current is applied to an electrochemical display element according to a display density to be displayed in the electrochemical display element, to display an image;
a first memory configured to store display density values X to be displayed next respectively in each electrochemical display element;
a second memory configured to store display density values Y being currently displayed respectively in each electrochemical display element;
an input section which obtains location information of a user input on the display screen;
a first updating section for updating the display density value X which is being stored in the first memory, whereby the display density value X of the electrochemical display element corresponding to location information which has been obtained by the input section is updated;
a comparison section which compares the display density value X stored in the first memory with the display density value Y of the corresponding electrochemical display element stored in the second memory;
a driver for applying a writing current to each electrochemical display element based on a result of the comparison by the comparison section; and,
a second updating section for updating the display density value Y which is being stored in the second memory along with the application of the writing current by the driver,
wherein the first memory is a FIFO memory, and the updating of the display density value X which is being stored in the first memory by the first updating section and the comparison of the display density value X and the display density value Y by the comparison section are performed asynchronously.

19. The display device of claim 18, further comprising a third memory configured to store the display density values X for a plurality of pages to be stored in the first memory.

20. The display device of claim 18, wherein the input section is a touch panel provided in the top layer of the display screen.
